(19) United States
(12) Patent Application Publication
(10) Pub. No.: US 2021/0213874 A1
(43) Pub. Date: Jul. 15, 2021

(54) VEHICLE REARVIEW MIRROR CAPABLE OF ENHANCING ILLUMINOUS INTENSITY

(71) Applicant: Nan-Hsin CHANG, SIANSI TOWNSHIP (TW)

(72) Inventor: Nan-Hsin CHANG, SIANSI TOWNSHIP (TW)

(21) Appl. No.: 17/034,436

(22) Filed: Sep. 28, 2020

(30) Foreign Application Priority Data
Jan. 10, 2020 (TW) 109100941

(51) Int. Cl. B60Q 1/26; B60R 1/02; B60R 1/12; B60Q 1/00; F21V 8/00

(52) U.S. Cl. CPC B60Q 1/2665; B60R 1/02; B60R 1/1207; G02B 6/0041; G02B 6/0053; G02B 6/0055; G02B 6/0068; B60Q 1/0011

(57) ABSTRACT

A vehicle rearview mirror is described to include a reflector having a light-transmissive pattern, and a light emitting module including a case, a light source and a light guide. The case has an inner surface to reflect light. The light guide is disposed in the case and has an illuminating surface and a prism surface opposite to the illuminating surface for total reflection. The light guide is further provided on a side thereof with an incidence surface. The light source is disposed in the case and faces the incidence surface in a way that the light emitted by the light source incidents into the light guide through the incidence surface and it is reflected by the prism surface and the inner surface as much as possible toward the illuminating surface to show the light-transmissive pattern.

### BACKGROUND OF THE INVENTION

### 1. Field of the Invention

The present invention is a rearview mirror for general vehicles.

### 2. Description of the Related Art

A blind spot monitoring system detects objects around the body of a vehicle by a detector installed on the body of the vehicle. When the detector detects an object such as another vehicle, the driver is alerted through vision, hearing or vibration, which aids the driver to compensate the visual blind spots around the vehicle to ensure driving safety.

In the conventional art, for example, U.S. Pat. No. 9,227,557 B2 describes a vehicle rearview mirror with an indicate function. Referring to FIG. 2 of the aforementioned patent, it is noted that the mirror surface 20 is provided with a light-transmissive zone 21 and an indicator device 30 is disposed behind the mirror surface 20. The indicator device 30 includes a reflection base 31 and light emitting members 32. The light emitting members 32 face a reflecting surface 311 of the reflection base 31, so that the light emitted by the light emitting members 32 is reflected by the reflecting surface 311 to the light-transmissive zone 21 to indicate the user.

However, the conventional indicator device 30 of the rearview mirror usually uses LEDs (light emitting diodes) as the light emitting members 32, and the LEDS are linear light sources only applicable to a small-area light-transmissive zone 21 as described in the above-mentioned patent, but inapplicable to a light-transmissive zone with a large area or a customized pattern, thereby limited in usage and still improvable. On the other hand, the emitted light emitted through the light-transmissive zone of the conventional rearview mirror is insufficient in illuminous intensity, so that the shown customized pattern would be dim and difficult to recognize. Thus, there is room for improvement.

### SUMMARY OF THE INVENTION

It is one of the objectives of the present invention to make an improvement aimed at the defects of the conventional rearview mirrors so as to provide an improved vehicle rearview mirror which can show a customized pattern with a larger area.

It is still another objective of the present invention to provide a novel rearview mirror, which emits light with higher illuminous intensity through the light-transmission zone of the rearview mirror to better show the customized pattern.

A vehicle rearview mirror according to an embodiment of the present invention is provided to include a reflector and a light emitting module. The reflector has a back surface provided with a light-transmissive pattern for alerting or instructing the driver. The light emitting module is disposed behind the reflector and includes a case, a light source and a light guide. The case is provided with an opening and an inner surface facing the opening. The light guide is disposed in the case and has an illuminating surface and a prism surface provided opposite to the illuminating surface for total reflection. The light guide is provided on a side thereof with an incidence surface. The light source is disposed in the case and faces the incidence surface in a way that the light emitted by the light source incidents into the light guide through the incidence surface and the aforementioned prism surface reflects the light emitted by the light source to the illuminating surface which faces the light-transmissive pattern, thereby showing the light-transmissive pattern. The illuminating surface faces backward the inner surface and the prism surface faces the inner surface. The inner surface reflects the light emitted from the light source.

Through the structural design of the above-described rearview mirror, the light emitted by the light source is guided by the light guide to be uniformly projected from the illuminating surface and evenly distributed over the entire illuminating surface, so that the light emitting module is capable of projecting a large-area light. In other words, the whole light emitting module can be regarded as a surface light source, thereby applicable to various light-transmissive patterns with large area and customized design. Further, based on that the inner surface is capable of reflecting light emitted from the light source, the light emitted from the light source is under multiple reflection by the light guide and the inner surface. Therefore, the illuminous intensity of the emitted light emitted from the light emitting module toward the light-transmissive pattern is enhanced to better show the customized pattern.

In one of the aspects, the rearview mirror may be a rear-view mirror inside the vehicle or a side-view mirror outside the vehicle.

In another aspect, there are at least following two methods to enhance the light reflectance of the inner surface, one of the which is to coat a layer of metal film on the inner surface of the case to render the inner surface of the light emitting module to reflect the light emitted from the light source by the layer of the metal film. Another method is to provide a reflector inside the light emitting module and render the reflector being disposed on the inner surface of the case, so that the inner surface of case can be used for reflecting the light emitted from the light source by the abovementioned reflector. Optionally, the inner wall of the case may have a plurality of positioning member to fixedly mount the abovementioned reflector.

In another aspect, the prism surface is a sawtooth surface.

In another aspect, the light source includes an LED array and the light source is fixed in the case.

In another aspect, the illuminating surface is a flat plane.

In another aspect, the light guide includes light diffusing agent therein.

In another aspect, for making the light emitting module stably fixed to the reflector and face the light-transmissive pattern, the light emitting module may be directly connected to the back surface of the reflector. In an alternative, the case of the light emitting module may be provided on the outer surface thereof with a bump in a way that the light emitting module can be directly connected to the back surface of the reflector by the bump.

### BRIEF DESCRIPTION OF THE DRAWINGS

The detailed structure, features and assembly or usage manners of the vehicle rearview mirror of the present invention will be specified in a following embodiment, but it should be understood that the following embodiment and the accompanying drawings are given for illustration only, not limitative of the claimed scope of the present invention, and wherein:

FIG. 1 is a perspective view of a vehicle rearview mirror of the embodiment in accordance with first embodiment;

FIG. 2 is approximately a side view of FIG. 1 and neglect showing a mirror mount of the rearview mirror;

FIG. 3 is an exploded perspective view of a light emitting module of the embodiment in accordance with the first embodiment;

FIG. 4 is a sectional view of the light emitting module in accordance with the first embodiment;

FIG. 5 is a perspective view of a light guide of the light emitting module of the embodiment in accordance with the first embodiment;

FIG. 6 is a block diagram showing the operation of a blind spot monitoring system of the embodiment in accordance with the first embodiment;

FIG. 7 is an explosive view of the vehicle rearview mirror in accordance with second embodiment; and

FIG. 8 is a sectional view of the vehicle rearview mirror in accordance the second embodiment.

### DETAILED DESCRIPTION OF THE INVENTION

The technology and features of the present invention will be specified in a following embodiment and the appendix drawings. The directional terms mentioned in the contents of the specification, such as ‘above’, ‘below’, ‘inside’, ‘outside’, ‘top’ and ‘bottom’, are just for illustrative description on the basis of normal usage direction, not intended to limit the claimed scope.

For specifying the technical features of the present invention, a following two embodiments and the appendix drawings are given hereunder. Both of the two embodiments take a side-view mirror outside the vehicle as illustrative examples of the rearview mirror.

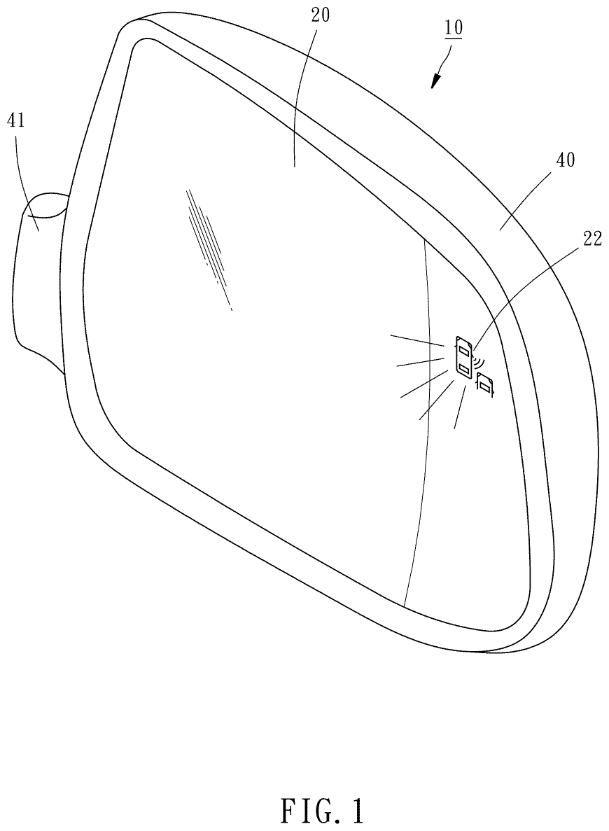

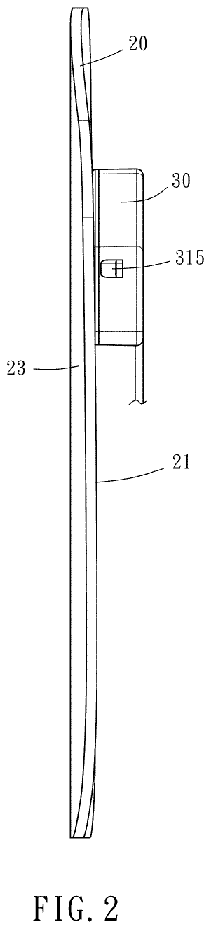

As shown in FIGS. 1-2, a rearview mirror 10 includes a reflector 20, a light emitting module 30 and a mirror mount 40, wherein the reflector 20 is a mirror mounted to the mirror mount 40 and the light emitting module 30 is disposed inside the mirror mount 40.

The reflector 20 is adapted to show objects located around the vehicle and provided on a back surface 21 thereof with a coating layer of aluminum or chromium for reflecting function. The coating layer is usually very thin, thereby it is not illustrated in FIG. 2. Besides, the coating layer is engraved with a light-transmissive pattern 22 by laser engraving, which is provided at a proper position on the back of the reflector 20, such as the position relatively far away from a connecting member 41 of the mirror mount 40 as shown in this embodiment, so that light can be transmitted through the light-transmissive pattern 22 from the back surface 21 of the reflector 20 to the front surface 23 of the reflector 20.

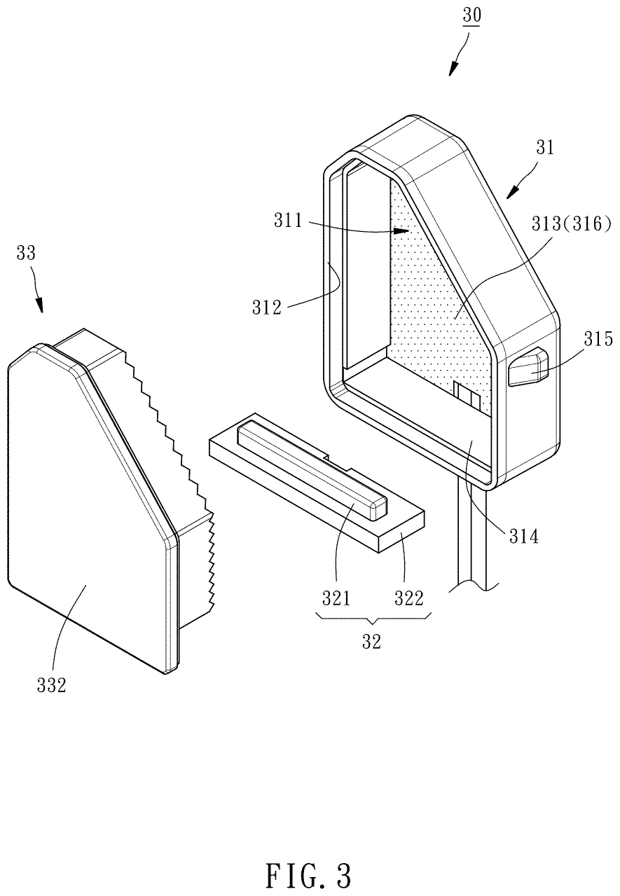

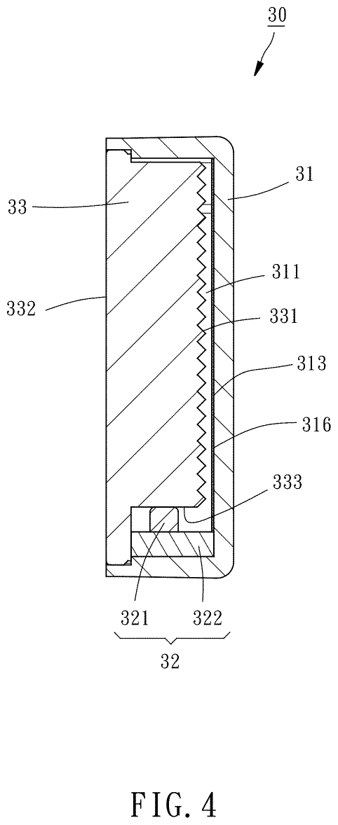

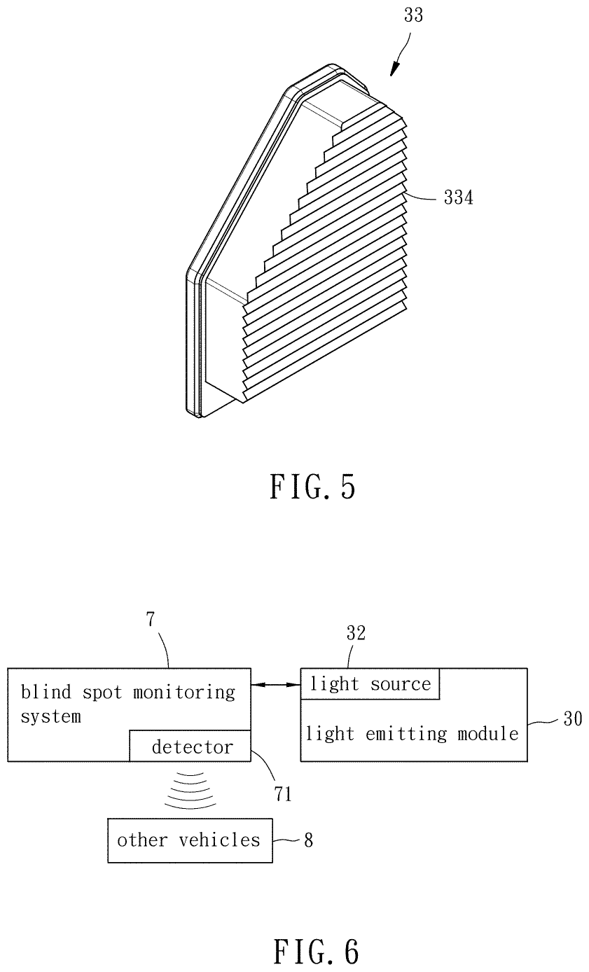

Referring to FIGS. 2-5, the light emitting module 30 includes a case 31, a light source 32 and a light guide 33. The case 31 is hollowed and has an accommodating room 311, an opening 312, an inner surface 313 and an installation surface 314. The accommodating room 311 communicates with the outside of the light emitting module 30 through the opening 312. The inner surface 313 faces the opening 312. The case 31 is made of plastic and provided on the inner wall thereof with a smooth metal film 316 by coating for reflecting function, so that the metal film 316 disposed on the inner surface 313 can be functioned to reflect light toward the opening. Besides, the case 31 is provided on the outer surface thereof with two bumps 315 in a way that the light emitting module 30 can be disposed behind the reflector 20 by the bumps 315. Only one of the bumps 315 is shown in FIGS. 2 and 3. As shown in FIGS. 3-5, the light guide 33 is made of acrylic and includes light diffusing agent therein for increasing the light diffusivity of the light guide 33. The light guide 33 is fixed to the case 31 by ultrasonic welding (or gluing) and covers the opening 312. The light guide 33 has a prism surface 331 and an illuminating surface 332 which are provided opposite to each other. Besides, the light guide 33 is provided on a side thereof with an incidence surface 333. The illuminating surface 332 is a flat plane and the illuminating surface 332 backward faces inner surface 313. The illuminating surface 332 is aligned to be parallel to the inner surface 313. The prism surface 331 is a sawtooth surface including a plurality of triangle sections 334 as shown in FIG. 5. The triangle sections 334 extend transversely and are arranged equidistantly. The incidence surface 333 is a flat plane facing the installation surface 314. The light source 32 in this embodiment uses LED, which includes an LED array 321 fixed on a substrate 322 by integrated circuit packaging. The light source 32 is fixed on the installation surface 314 in the accommodating room 311. The LED array 321 can be controlled to emit light in a way that the light emitted by the light source 32 incidents into the light guide 33 through the incidence surface 333 and reflected or totally reflected to the illuminating surface 332 by the prism surface 331. A fraction of light transmits out of the prism surface 331 will re-incident into the light guide 33 due to the functioning of the reflection of the inner surface 313, and finally transmits out of the illuminating surface 332. (the fraction of light may be under multiple reflection inside the light guide 33), so that a large-area light is uniformly projected from the illuminating surface 332 to illuminate and show the light-transmissive pattern 22. It is noted that, under the augment of the inner surface 313, the inner surface 313 is capable of reflecting the light emitted from the light source 32, and further under the augment of the light guide 33 and the inner surface 313, the illuminous intensity of the light projected from the light emitting module 30 toward the light-transmissive pattern is enhanced to show the customized light-transmissive pattern better.

Referring to FIG. 6, through the structural design of the above-described rearview mirror 10, when a detector 71 of a blind spot monitoring system 7 of the vehicle detects another vehicle 8 (or a pedestrian) around the vehicle, the blind spot monitoring system 7 activates the light source 32 to emit light, so that the light emitted by the light source 32 is affected by the light guide 33 to be projected uniformly as a large-area light to the light-transmissive pattern 22, thereby showing the light-transmissive pattern 22 to alert the driver for ensuring the driving safety. Through the effect of the light guide 33 broadening the area of the light, the entire light emitting module 30 can be regarded as a surface light source, thereby applicable to various light-transmissive patterns 22 with large area and customized design. Further, under the augment of the inner surface 313, the illuminous intensity of the light projected from the light emitting module 30 toward the light-transmissive pattern 22 is enhanced, so that the light-transmissive pattern 22 can be further seen clearly.

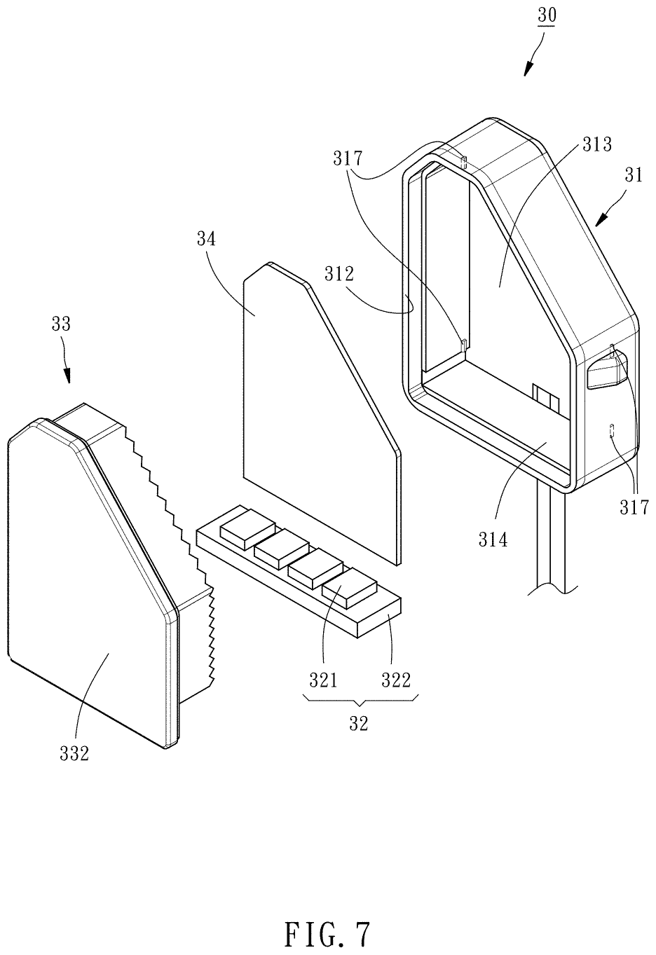

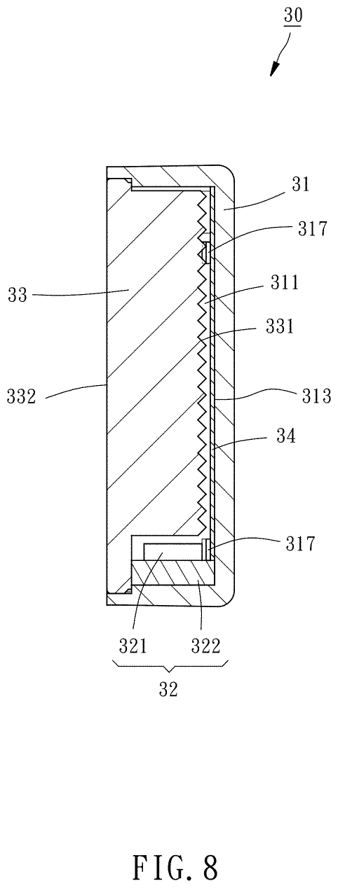

The present invention further provides a second embodiment. Please take reference to FIG. 7 and FIG. 8. The structure of the light emitting module 30 is basically the same with the light emitting module 30 shown in the first embedment. One of the differences of the second embodiment lies in that the inner surface 313 of the case 31 is not coated with metal film. Instead, a sheet of reflector 34 is provided inside the light emitting module 30. The reflector 34 is slightly bendable and flexible and it is mounted on the inner surface 313. Specifically, the reflector 34 has a plastic sheet and a layer of metal film provided on the plastic sheet. The case 31 further includes four positioning members 317 which are integrally connected with four corners of the inner wall of the case 31. In the second embodiment, the positioning member 317 is a bump in structure, and the four positioning members 317 jointly fix the reflector 34. Under the augment of the reflector 34, the illuminous intensity of the light projected from the light emitting module 30 toward the light-transmissive pattern 22 can also be enhanced to show the customized light-transmissive pattern 22 better.

The above description is only an instanced embodiment of the present invention, and all equivalent changes and modifications made in accordance with the following claims should be included within the scope of the present invention.

What is claimed is:

1. A vehicle rearview mirror capable of enhancing illuminous intensity, comprising:
a reflector having a back surface provided with a light-transmissive pattern; and
a light emitting module being disposed behind the reflector, the light emitting module comprising a case, a light source and a light guide, the case having an opening and an inner surface facing the opening, the light guide being disposed in the case and having an illuminating surface and a prism surface opposite to the illuminating surface for total reflection, the light guide being provided on a side thereof with an incidence surface, the light source being disposed in the case and facing the incidence surface in a way that light emitted by the light source incidents into the light guide through the incidence surface and the prism surface reflects the light emitted by the light source to the illuminating surface;
wherein the illuminating surface faces the light-transmissive pattern; the illuminating surface faces backward the inner surface and the prism surface faces the inner surface, and the inner surface reflects the light emitted from the light source.

2. The vehicle rearview mirror as claimed in claim 1, wherein the inner surface is coated with a layer of metal film, and the inner surface reflects the light emitted from the light source by the metal film.

3. The vehicle rearview mirror as claimed in claim 1, wherein the light emitting module further has a reflector; the reflector is mounted on the inner surface, and the inner surface reflects the light emitted from the light source by the reflector.

4. The vehicle rearview mirror as claimed in claim 3, wherein the case further includes a plurality of positioning members for fixing the reflector.

5. The vehicle rearview mirror as claimed in claim 1, wherein the prism surface is a sawtooth surface.

6. The vehicle rearview mirror as claimed in claim 1, wherein the light source includes an LED array and the light source is fixed in the case.

7. The vehicle rearview mirror as claimed in claim 1, wherein the illuminating surface is a flat plane.

8. The vehicle rearview mirror as claimed in claim 1, wherein the light guide comprises light diffusing agent therein.

9. The vehicle rearview mirror as claimed in claim 1, wherein the light emitting module is directly connected to the back surface of the reflector.

10. The vehicle rearview mirror as claimed in claim 1, wherein the case is provided on an outer surface thereof with a bump; the light emitting module is directly connected to the back surface of the reflector by the bump.
